(19) United States
(12) Patent Application Publication
(10) Pub. No.: US 2014/0027474 A1
(43) Pub. Date: Jan. 30, 2014

(54) Sleeve For The Sealed Fastening Of A Dispensing Member In The Neck Of A Bottle For The Conditioning Of A Liquid Product To Be Dispensed

(71) Applicants: Pierre Dumont, Dargnies (FR); Herve Lompech, Ansennes Bouttencourt (FR); Thomas Pruvost, Saint Quentin La Motte (FR)

(72) Inventors: Pierre Dumont, Dargnies (FR); Herve Lompech, Ansennes Bouttencourt (FR); Thomas Pruvost, Saint Quentin La Motte (FR)

(21) Appl. No.: 13/953,217

(22) Filed: Jul. 29, 2013

(30) Foreign Application Priority Data
Jul. 27, 2012 (FR) 1257306

(51) Int. Cl. B65D 88/54; B65D 83/00

(52) U.S. Cl. CPC B05B 11/3045
USPC 222/321.1; 222/402.1

(57) ABSTRACT

A sleeve for the sealed fastening of a dispensing member in the neck of a bottle for the conditioning of a liquid product to be dispensed, the sleeve having an external skirt intended to be locked onto the outer wall of the neck and an internal reinforcement wherein the dispensing member is intended to be fixed in a sealed manner, the internal reinforcement having two exterior surfaces respectively lower and upper, each of the surfaces having an interference diameter allowing for the sealed clamping of the surface onto an inner wall of a neck, the diameter of the surfaces being different in such a way that the sleeve allows for the sealed fastening of a dispensing member indifferently onto two types of necks.

### FIELD OF THE INVENTION

The invention relates to a sleeve for the sealed fastening of a dispensing member in the neck of a bottle for conditioning a liquid product to be dispensed, as well as a bottle for conditioning comprising such a sleeve.

### BACKGROUND OF THE INVENTION

In order to dispense a liquid product, in particular a liquid or a cream, for example a perfume, a cosmetic product or a pharmaceutical product, bottles for dispensing are known having a re wherein said product is conditioned and a neck surmounting said reservoir by defining an upper opening.

The bottle further comprises a dispensing member which is mounted in the upper opening by arranging the means of supplying said member inside the reservoir in order to allow for the restitution of the product conditioned in said reservoir. In particular, the dispensing member can be a pump actuated by a push-button.

In order to provide for the sealed fastening of the dispensing member in the neck, the use of a sleeve is known having an external skirt intended to be locked onto the outer wall of the neck and an internal reinforcement wherein the dispensing member is intended to be fastened in a sealed manner. Moreover, the internal reinforcement has an exterior surface making it possible to form the seal between the sleeve and the inner wall of the neck via sealed clamping of said surface onto said wall.

However, in order to allow for the fastening of a dispensing member onto several types of bottles, it is required to carry out a sleeve via the inside neck diameter since the exterior surface of said sleeve has to be clamped onto the inner wall of said neck in order to provide the seal.

In particular, the known sleeves do not allow for the fastening of a dispensing member indifferently in a glass neck and in a plastic neck since the thickness of a glass neck is conventionally thicker than that of a plastic neck.

### SUMMARY OF THE INVENTION

The invention aims to improve prior art by proposing in particular a sleeve for the fastening of a dispensing member indifferently onto two types of necks, in particular onto a glass neck and onto a plastic neck, which have an inside diameter and/or a thickness that is different.

To this effect, according to a first aspect, the invention proposes a sleeve for the sealed fastening of a dispensing member in the neck of a bottle for the conditioning of a liquid product to be dispensed, said sleeve having an external skirt intended to be locked onto the outer wall of the neck and an internal reinforcement wherein the dispensing member is intended to be fastened in a sealed manner, the internal reinforcement having two exterior surfaces respectively lower and upper, each of said surfaces having an interference diameter allowing for the sealed clamping of said surface onto an inner wall of a neck, said diameter of said surfaces being different in such a way that the sleeve allows for the sealed fastening of a dispensing member indifferently onto two types of necks.

According to a second aspect, the invention proposes a bottle for the dispensing of a liquid product having a reservoir wherein said product is conditioned, said reservoir being surmounted by a neck wherein an dispensing member is fastened by means of such a sleeve, the external skirt being locked onto the outer wall of the neck and the dispensing member being fastened in a sealed manner in the internal reinforcement, the inner wall of the neck being arranged in order to allow for the sealed clamping onto it of one of the exterior surfaces.

### BRIEF DESCRIPTION OF THE DRAWINGS

Other purposes and advantages of the invention shall appear in the following description, made in reference to the annexed figures, wherein:

FIG. 1 shows a longitudinal cross-section (with the dispensing member not being cut) of a first type of bottle for dispensing comprising a sleeve for fastening according to an embodiment of the invention, with the FIG. 1a being an enlarged view of a neck zone of FIG. 1;

FIG. 2 shows a longitudinal cross-section (with the dispensing member not being cut) of a second type of bottle for dispensing comprising the sleeve for fastening of FIG. 1, with the FIG. 2a being an enlarged view of a neck zone of FIG. 2.

### DETAILED DESCRIPTION OF THE INVENTION

In the description, the terms for positioning in space are taken in reference to the position of the bottle shown in the figures. A bottle intended to contain a liquid product for the purposes of dispensing it is described hereinbelow. In particular examples, the product can be a liquid or a cream, for example a perfume, a cosmetic product or a pharmaceutical product.

The bottle can be formed of a rigid material, in particular of glass or of a plastic material, in order to comprise a body 1 defining a reservoir 2 for the conditioning of the product. The body 1 is surmounted by a neck 3 formed from a single piece with said body by defining an upper opening for the reservoir 2.

The bottle for dispensing further comprises a dispensing member 4 mounted in the upper opening by arranging the means for supplying said member inside the reservoir 2. In the embodiments shown, the dispensing member is a pump 4 actuated by a push-button 5 provided with a dispensing orifice 6. Alternatively, the dispensing member 4 can be a valve making it possible to restore a product conditioned under pressure in the reservoir 2.

The dispensing member 4 comprises a body 7 wherein are housed means for restoring under pressure the product conditioned. The lower portion of the body 7 is provided with a supply orifice, with the means for supplying comprising a dip tube 8 having an upper portion connected to the supply orifice and a lower portion arranged in the reservoir 2.

According to a known embodiment, the pump 4 comprises a nozzle 9 whereon the push-button 5 is mounted in order to actuate it in reversible translation onto a course for dispensing, a piston also being mounted on the nozzle 9 between a closed state and a state of supplying the orifices of said nozzle. However, the invention is not limited to a particular operating mode of the dispensing member 4.

The bottle further comprises a sleeve 10 for the sealed fastening of the dispensing member 4 in the neck 3, said sleeve able to have a cylindrical revolution geometry and be made of a single piece with a ductile material base such as a plastic material of the polyolefin type. In particular, the sleeve 10 can be arranged in order to conceal the neck 3 of the bottle and/or the connection of the dispensing member 4 to the bottle.

The sleeve 10 has an external skirt 11 arranged around the outer wall of the neck 3 in order to conceal said neck. In the embodiment shown, the skirt 11 is surmounted by a well 12 wherein the push-button 5 is arranged in translation, in order to in particular conceal the nozzle 9, with the outside diameter of said well and of said skirt being the same.

In order to lock the sleeve 10 on the neck 3, the external skirt 11 has means of locking 13 on the outer wall of the neck 3. In the embodiment shown, the inner wall of the skirt 11 is provided with means of snap-fitting formed from an inner ring 13 intended to be locked under a groove 14 formed on the outer wall of the neck 3. The sleeves 10 according to this embodiment have the advantage of being able to be mounted on the bottles quickly and reliably, without requiring any specific tool such as crimping pliers, without any torque guidelines to be provided, without the risk of self-unscrewing, and are inviolable. Alternatively, the means of locking 13 can allow for the screwing of the sleeve 10 on the neck 3.

The sleeve 10 also has an internal reinforcement 15 wherein the dispensing member 4 is fixed in a sealed manner, the external skirt 11 extending axially downwards and concentrically around the internal reinforcement 15. In the embodiment shown, the internal reinforcement 15 has an axial crown 16 which is connected to the external skirt 11 by the intermediary of a radial plate 17 which extends interiorly at the junction between the skirt 11 and the well 12.

The body 7 of the dispensing member 4 is arranged inside the radial plate 17 in order to slide axially in the internal reinforcement 15 in order to be fastened therein in a sealed manner, said body having a flange 18 which is pressing axially on the radial plate 17 in order to define the end of the travel of said sliding.

The axial crown 16 is extended by an axial extension 19 which is formed opposite the radial plate 17, said extension being connected to said crown by an interior shoulder 20. The axial extension 19 has an interior surface 21 which is clamped around the body 7 of the dispensing member 4 in order to provide its sealed fastening.

The internal reinforcement 15 has two exterior surfaces respectively lower 22 and upper 23, each of said surfaces having an interference diameter Di, Ds allowing for the sealed clamping of said surface onto an inner wall of a neck 3. In particular, the sealed clamping is carried out, during the sliding of the sleeve 10 inside the neck 3, via a radial pressing of two planar cylindrical surfaces of substantially the same diameter. In the embodiment shown, the upper 23 and lower 22 surfaces are formed on the exterior of the axial crown 16 and of the axial extension 19, respectively.

This seal via clamping is particularly advantageous in relation with a sleeve 10 provided with means of snap-fitting 13 of the skirt 11 on the neck 3 since, during the snapping, the sleeve 10 is slightly compacted until the nesting of the means for snap-fitting 13 then is relaxed, which induces a possible variation in the axial positioning of the sleeve 10 on the bottle.

The interference diameter Ds, Di of the upper 23 and lower 22 surfaces is different, with the lower surface 22 being able in particular to have an interference diameter Di which is lower than the interference diameter Ds of the upper surface 23. As such, the sleeve 10 allows for the sealed fastening of a dispensing member 4 indifferently on two types of necks 3 of which the inner wall is arranged in order to allow for the sealed clamping onto it of one of the exterior surfaces 22, 23, with the other exterior surface 23, 22 able in particular to remain free. Alternatively, the internal reinforcement 15 can have more than two exterior surfaces each having an interference diameter that is different so that the sleeve 10 allows for the fastening of the dispensing member 4 indifferently on more than two types of necks 3.

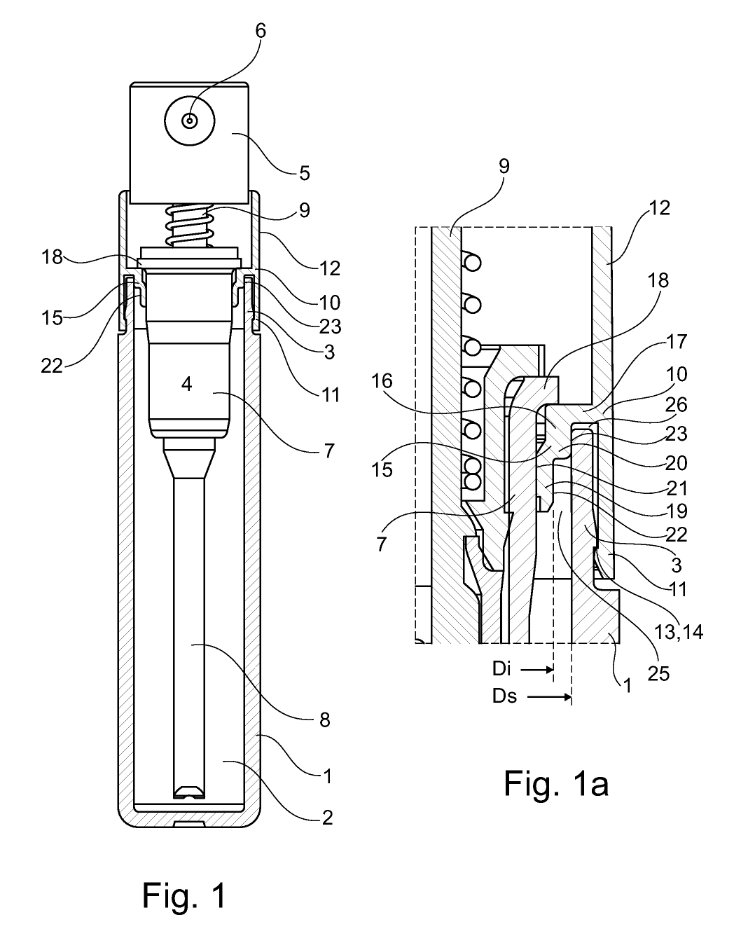

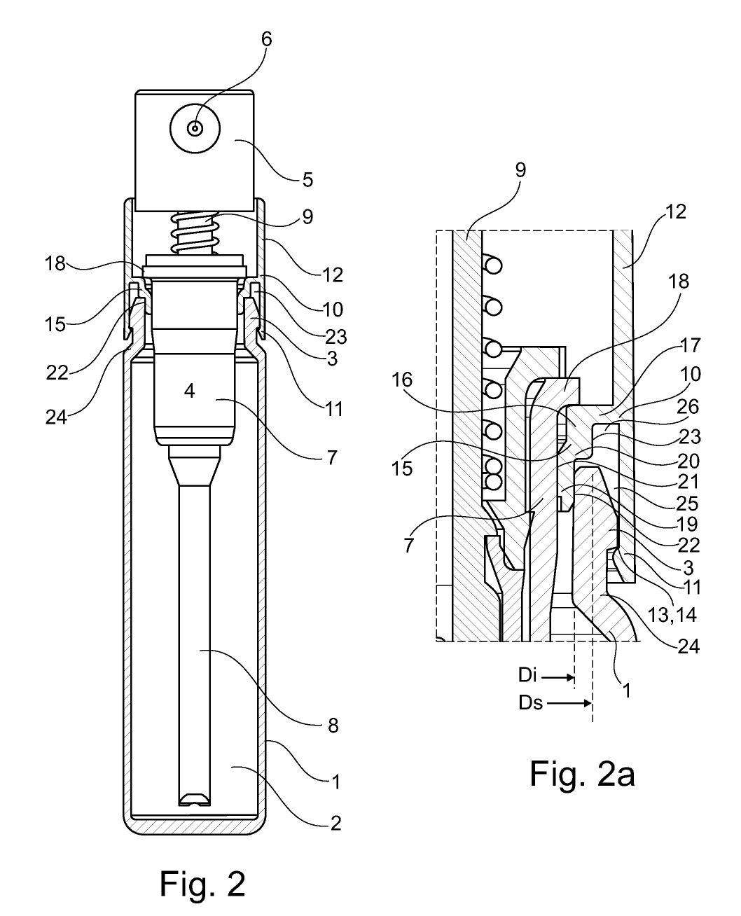

The sleeve 10 allows in particular for the fastening of the dispensing member 4 on the neck 3 of a bottle made of plastic (FIGS. 1) and of glass (FIGS. 2). The glass neck 3 has a thickness that is thicker than that of the plastic neck 3, i.e., for a given outside diameter, it has an inside diameter which is lower. In particular, the neck 3 of the glass bottle is connected to the body 1 by an interior shoulder 24 although the neck 3 of the plastic bottle is arranged in the extension of the body 1.

In order to take this difference in thickness into account, an annular housing 25, 26 is defined between the external skirt 11 and each exterior surface 22, 23, each housing 25, 26 being arranged so that a neck 3 can be arranged therein with said skirt locked onto the outer wall of said neck and said exterior surface clamped onto the inner wall of said neck.

As such, in the FIGS. 1, the neck 3 is arranged in the upper housing 26 with reduced thickness. In particular, the locking ring of the neck 3 is arranged under the radial plate 17, the sleeve 10 being clamped in a sealed manner onto the inner wall of said neck by the intermediary of the upper surface 23 and locked onto the outer wall of said neck by snap-fitting.

In the FIGS. 2, the neck 3 is arranged in the lower housing 25 with a greater thickness. In particular, the locking ring of the neck 3 is arranged under the shoulder 20, the sleeve 10 being clamped in a sealed manner onto the inner wall of said neck by the intermediary of the lower surface 22 and locked onto the outer wall of said neck par snap-fitting.

Furthermore, the clamping of one of the exterior surfaces 22, 23 onto the inner wall of the neck 3 favours, via internal deformation of the reinforcement 15, the sealed clamping of the lower surface 21 onto the exterior of the body 7 of the dispensing member 4, in order to further render reliable the sealed mounting of said member on the neck 3 by the intermediary of the sleeve 10.

Moreover, the exterior surfaces 22, 23 can be tapered so that their sealed clamping onto the inner wall of the neck 3 is carried out via relative sliding relative until the interference diameter. As such, the locking ring of the neck 3 can be arranged at an axial distance from the radial plate 17 respectively from the shoulder 20 in order to guarantee the sealed clamping.

The fastening of the dispensing member 4 in the neck 3 can be carried out in a particularly simple manner and indifferently in terms of the type of neck 3 under consideration, by introducing the dispensing member 4/sleeve 10 unit into said neck until locking of the external skirt 11 onto the outer wall of said neck and sealed clamping of one of the exterior surfaces 22, 23 onto the inner wall of said neck.

1. A sleeve for the sealed fastening of a dispensing member in the neck of a bottle for conditioning a liquid product to be dispensed, said sleeve having an external skirt intended to be locked onto the outer wall of the neck and an internal reinforcement wherein the dispensing member is intended to be fastened in a sealed manner, said sleeve characterised in that the internal reinforcement has two exterior surfaces respectively lower and upper, with each of said surfaces having an interference diameter allowing for the sealed clamping of said surface onto an inner wall of a neck, said diameter of said surfaces being different in such a way that the sleeve allows for the sealed fastening of a dispensing member indifferently onto two types of necks.

2. The sleeve according to claim 1, characterised in that the internal reinforcement has an axial crown on the exterior of which the upper surface is formed, said crown being extended by an axial extension over the exterior of which the lower surface is formed.

3. The sleeve according to claim 2, characterised in that the axial extension has an interior surface which is intended to be clamped around the dispensing member in order to provide for its sealed fastening.

4. The sleeve according to claim 2, characterised in that axial crown is connected to the external skirt by the intermediary of a radial plate.

5. The sleeve according to claim 1, characterised in that the lower surface has an interference diameter which is less than the interference diameter of the upper surface.

6. The sleeve according to claim 1, characterised in that the external skirt comprises means of snap-fitting of the sleeve onto the outer wall of the neck.

7. the sleeve according to claim 1, characterised in that the exterior surfaces are tapered so that their sealed clamping onto the inner wall of the neck is carried out via relative sliding until the interference diameter.

8. The sleeve according to claim 1, characterised in that an annular housing is defined between the external skirt and each exterior surface, each housing being arranged so that a neck can be arranged therein with said skirt locked onto the outer wall of said neck and said exterior surface clamped onto the inner wall of said neck.

9. The sleeve according to claim 1, characterised in that the external skirt extends axially around the internal reinforcement.

10. The sleeve according to claim 1, characterised in that it is made of one piece.

11. A bottle for dispersing a liquid product having a reservoir wherein said product is conditioned, said reservoir being surmounted by a neck wherein a dispensing member is fastened by means of a sleeve according to claim 1, the external skirt being locked onto the outer wall of the neck and the dispensing member being fastened in a sealed manner in the internal reinforcement, the inner wall of the neck being arranged in order to allow for the sealed clamping onto it of one of the exterior surfaces.

12. The bottle for dispensing according to claim 11, characterised in that the other exterior surface is free.

13. The sleeve according to claim 3, characterised in that axial crown is connected to the external skirt by the intermediary of a radial plate.
